(19) United States
(12) Patent Application Publication
(10) Pub. No.: US 2013/0118764 A1
(43) Pub. Date: May 16, 2013

(54) SMOKE, SOUND AND FIRE RESISTANT BLANKET

(71) Applicant: Raymond Porter, Heathfield (AU)

(72) Inventor: Raymond Porter, Heathfield (AU)

(21) Appl. No.: 13/811,277

(22) PCT Filed: Jun. 23, 2011
(86) PCT No.: PCT/AU11/00775

§ 371 Date: Jan. 20, 2013

(30) Foreign Application Priority Data
Jul. 22, 2010 (AU) 2010903284

(51) Int. Cl. A62C 2/06; A62C 8/06

(52) U.S. Cl. CPC A62C 2/06; A62C 8/06
USPC 169/48

(57) ABSTRACT

A flexible fire, sound and smoke barrier (30) has a sheet of flexible intumescent material (32) and a sheet of smoke impermeable material (34) on both sides of the intumescent material. The smoke impermeable material comprising a woven or non-woven sheet of fibrous material (35) and a coating of a polymeric material (36) on at least one side of each sheet. The intumescent material comprises a formulation of expandable graphite, binders and plasticisers. The smoke impermeable material comprise a fibreglass fibrous material. The coating on the sheets of smoke impermeable material can be a polyurethane polymeric material. The sheet of flexible intumescent material can have a fibrous reinforcement (40) such as a sheet of textile material embedded into the intumescent material. Alternatively the fibrous reinforcement can be a metal mesh. The barrier can be formed in a strip with hook and loop fasteners along opposite edges and sides so that the barrier can be fixed around pipes and cables. Alternatively the acoustic, fire and smoke barrier blanket can be retained onto structures and around building services by gluing, stitching, strapping or stapling.

### FIELD OF INVENTION

This invention relates to a device for use in building construction and more particularly a device to prevent transfer of smoke, sound and fire between building spaces and to protect articles and structures within building structures particularly from smoke and fire.

### BACKGROUND

In the many situations it is desirable to prevent transfer of fire, sound and smoke between one part of a building and another or to prevent damage to ductwork, electricity wires and the likes.

Rigid structures have been proposed for this purpose but these can be difficult to install and cannot provide a flexibility which is often desirable.

### BRIEF DESCRIPTION OF THE INVENTION

In one form the invention comprises a flexible fire, sound and smoke barrier comprising a sheet of flexible intumescent material, the sheet of flexible intumescent material comprising a first side and a second side, and first sheet of smoke impermeable material on the first side of the sheet of flexible intumescent material and the first sheet of smoke impermeable material being fastened to the first side of the sheet of flexible intumescent material and a second sheet of smoke impermeable material on the second side of the sheet of flexible intumescent material and the second sheet of smoke impermeable material being fastened to the second side of the sheet of flexible intumescent material, the first and second sheets of smoke impermeable material comprising a woven or non-woven sheet of fibrous material and a coating of a polymeric material on at least one side thereof.

Preferably the sheet of flexible intumescent material comprises a formulation of expandable graphite, binders and plasticisers and the sheet of flexible intumescent material comprises a thickness of from 1 mm to 10 mm.

The first and second sheets of smoke impermeable material can comprise a fibreglass fibrous material.

The coating of a polymeric material on at least one side of the first and second sheets of smoke impermeable material can comprise a polyurethane polymeric material.

The first and second sheets of smoke impermeable material can be fastened respectively to the sides of the sheet of flexible intumescent material by at least one of gluing, stitching or stapling.

The sheet of flexible intumescent material can further comprise a fibrous reinforcement. The fibrous reinforcement can for instance comprise a sheet of textile material embedded into the intumescent material. The sheet of textile material embedded into the intumescent material can comprise woven or non-woven fibreglass. Alternatively the sheet of flexible intumescent material can comprise a metal mesh reinforcement.

In one embodiment the fire, sound and smoke barrier comprises an elongate strip, the strip having opposite longitudinal edges and complementary hook and loop fastening bands being on the opposite longitudinal edges on opposite faces.

In an alternative form the invention comprises a flexible fire, sound and smoke barrier comprising a sheet of flexible intumescent material, the sheet of flexible intumescent material comprising a first side and a second side, and first sheet of smoke impermeable material on the first side of the sheet of flexible intumescent material and the first sheet of smoke impermeable material being stitched to the first side of the sheet of flexible intumescent material and a second sheet of smoke impermeable material on the second side of the sheet of flexible intumescent material and the second sheet of smoke impermeable material being stitched to the second side of the sheet of flexible intumescent material, the first and second sheets of smoke impermeable material comprising a woven or non-woven sheet of fibreglass material and a coating of a polymeric material on at least one side thereof and the sheet of flexible intumescent material comprises a fibrous reinforcement layer.

It will be seen that by this invention there is provided a flexible blanket, sheet or strip which can be wrapped around duct work, electricity wires or the like to provide protection to the duct work or wires for a period of time or the flexible blanket, sheet or strip can be supported or hung through a ceiling or void space to prevent access of fire and smoke across such a void or space.

Another situation where the device of the present invention may be useful is where a service duct of any sort passes through a barrier and it is desirable to keep temperature on the surface of the service duct low on a non-fire side of a barrier. The smoke and fire blanket of the present invention can be useful to wrap around such a service duct for some distance from the barrier to prevent heat access to the service duct near the barrier in the event of fire an therefore to reduce the transfer of heat along the service duct or pipe to a non-fire region. The service duct to which the present invention may be applicable to includes but is not limited to ducts, cables or pipes or even parts of the structure itself, for instance, steel or timber members which carry or support service lines of any sort within a building.

The device of the present invention may also be useful as an acoustic barrier to prevent the transmission of sound through ceiling voids for instance.

In an alternative form the invention resides in a flexible fire, sound and smoke barrier comprising a plurality of sheets of fire and smoke barrier as defined above, the plurality of sheets being fastened together. The plurality of sheets of fire and smoke barrier are fastened together by at least one of gluing, stitching or stapling. The plurality of sheets of fire and smoke barrier further include a heat reflective material layer between at least two of the plurality of sheets.

### BRIEF DESCRIPTION OF THE DRAWINGS

This then generally describes invention but to assist with understanding reference will be made to the accompanying drawings which show preferred embodiments of the invention.

In the drawings:

FIG. 1 shows a schematic cross section view of a first embodiment of acoustic, fire and smoke blanket according to the present invention;

FIG. 2 shows a schematic cross section view of an alternative embodiment of acoustic, smoke and fire barrier according to the present invention;

FIG. 3 shows a schematic cross section view of a further embodiment of acoustic, smoke and fire barrier according to the present invention;

FIG. 4 shows a schematic view of acoustic, smoke and fire barrier of FIG. 1 showing the various layers;

FIG. 5 shows a schematic view of acoustic, smoke and fire barrier of FIG. 2 showing the various layers;

FIG. 5A shows the schematic result of a fire impinging upon the acoustic, smoke and fire barrier according to the present invention;

FIG. 6 shows a schematic roof construction with an acoustic, smoke and fire barrier according to the invention installed in the roof space;

FIGS. 6A to 6C show alternative installations in a roof space;

FIG. 7 shows a duct such as an air-conditioning duct with a smoke and fire barrier according to the present invention wrapped around it;

FIG. 8 shows a cable duct with a smoke and fire harrier according to the present invention wrapped around it;

FIG. 9 shows an application of the device of the present invention used for prevention of heat transfer in the event of a fire along a pipe of cable duct and through a barrier such as a wall;

FIG. 10 shows an alternative embodiment of smoke and fire barrier according to the present invention;

FIG. 11 shows one application of the smoke and fire barrier of FIG. 10 wrapped around electrical cables;

FIG. 12 shows a further application of the smoke and fire barrier of FIG. 10 wrapped around a structural steel beam; and

FIG. 13 shows a further application of the smoke and fire barrier of FIG. 10 wrapped around a cable tray.

### DESCRIPTION OF PREFERRED EMBODIMENTS

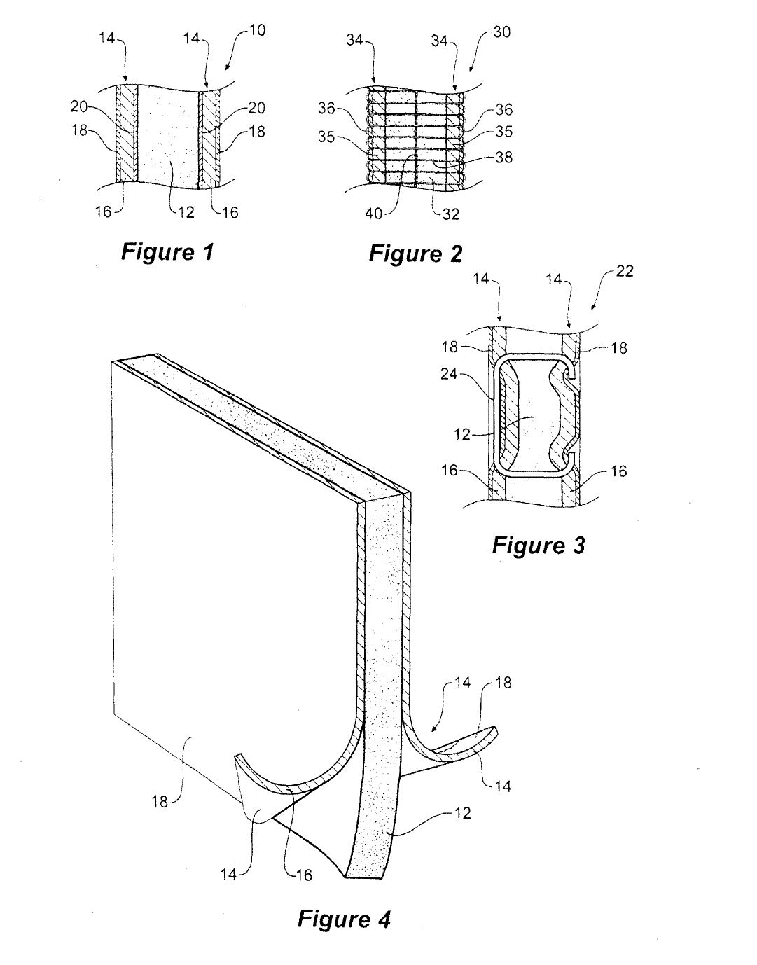

FIG. 1 shows one embodiment of an acoustic, smoke and fire barrier according to the present invention. The acoustic, smoke and fire barrier 10 comprises a layer of flexible intumescent material 12 and to each side of the intumescent material a sheet of smoke impermeable material 14. The smoke impervious material 14 comprises a layer of woven or non woven fibrous materials 16 with an outer coating 18 of a polymeric material. The smoke impervious material 14 is fastened to the intumescent material 20 by means of an adhesive layer 20.

In normal usage the acoustic, smoke and fire barrier according to the present invention extending across a void or ceiling space will provide a degree of acoustic insulation between parts of the void or ceiling space. In the event of a fire, before flames impinge directly onto one of the smoke impermeable material layers 14 the polymeric material will prevent transmission of smoke through the barrier. In the event of a fire impinging directly onto one of the smoke impermeable material 14 the polymeric outer layer 18 may char but heat will be transferred to the intumescent material which will expand and char and provide thermal insulation. The sheet of smoke impermeable material 14 on the side away from the fire will not char at least for a period of time and will continue to provide a smoke barrier to prevent smoke transmission across the barrier.

FIG. 2 shows an alternative embodiment of an acoustic, smoke and fire barrier according to the present invention. The acoustic, smoke and fire barrier 30 has an intumescent material 32 and a sheet of smoke impermeable material 34 on each side of the intumescent material 32. The smoke impermeable material 34 comprises a layer of woven or non woven fibrous materials 35 with an outer coating of a polymeric material 36 on the outer side of the fibrous layer 35. Stitching 38 is provided to hold the assembly together. The stitching extends right through all the layers 34, 35 and 36. In the middle of the flexible intumescent material is a fibrous reinforcement 40. The fibrous reinforcement material 40 within the intumescent material can be a textile material such as woven or nonwoven fibreglass, a fibreglass mesh material or a metallic mesh material. Preferably the fibrous reinforcement material 40 within the intumescent material is substantially resistant to decomposition by heat.

In the event of a fire impinging directly onto one of the smoke impermeable material 34 surfaces the stitches 38 will burn and hence the stitches will not provide an impediment to the expansion of the intumescent material. The fibrous reinforcement material 40 within the intumescent material provides a degree of structural strength so that in the event of the intumescent material charring in use the char will be supported to continue providing a smoke and fire harrier for a sufficient time for evacuation of a building, for instance.

FIG. 3 shows a still further embodiment of an acoustic, smoke and fire barrier according to the present invention. The acoustic, smoke and fire barrier 22 is similar in construction to the embodiment shown in FIG. 1 and the same reference numerals are used for corresponding items. The acoustic, smoke and fire barrier 22 comprises a layer of flexible intumescent material 12 and to each side of the intumescent material a sheet of smoke impermeable material 14 the smoke impervious material 14 comprises a layer of woven or non woven fibrous materials 16 with an outer coating 18 of a polymeric material. The smoke impervious material 14 is fastened to the intumescent material 12 by means of staples 24 which extend through the impervious material 14 on one side then into the intumescent material 12 and then through the impervious material 14 on the other side. In the event of a fire impinging directly onto one of the smoke impermeable material 14 surfaces the intumescent material will expand and the staple will be pulled out from the layer 14 on the other side and the staples will not provide an impediment to the expansion of the intumescent material.

FIG. 4 shows embodiment of FIG. 1 and particularly showing that the three layers are all flexible. The three flexible layers comprise the intumescent material 12 and the two smoke impermeable material layers 14 with the smoke impermeable material layers comprising a layer of woven or non woven fibrous materials 14 with an outer coating of a polymeric material 18 on the outer side of the fibrous layer 16.

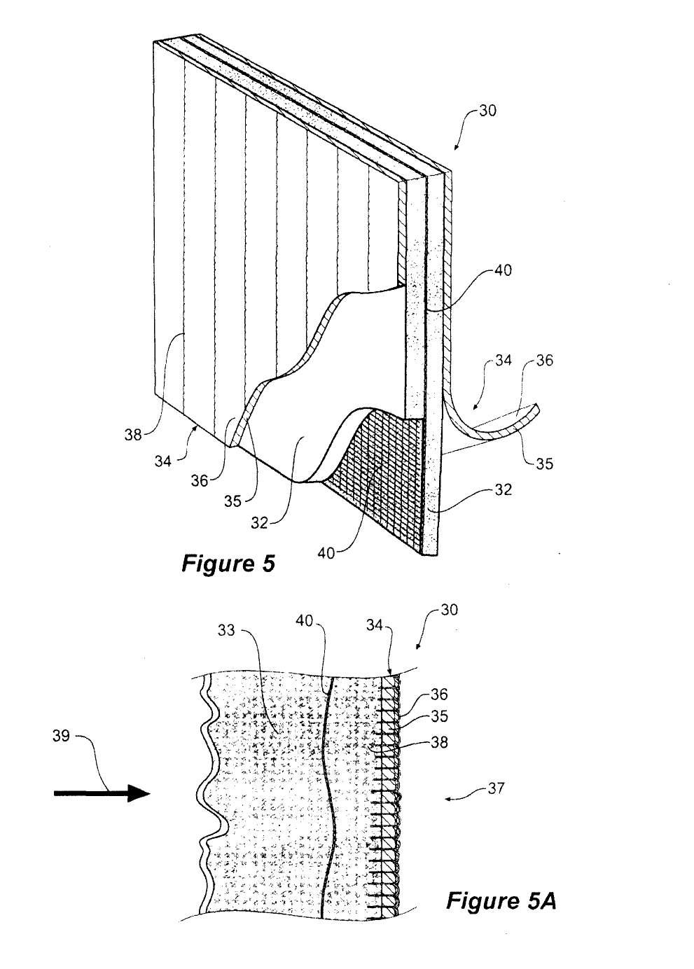

FIG. 5 shows embodiment of the acoustic, smoke and fire barrier 30 as shown in FIG. 2 and particularly showing that the layers are all flexible. The flexible layers comprise the intumescent material 32, the two smoke impermeable material layers 34 and within the flexible intumescent material is a fibrous reinforcement 40. As discussed above the smoke impermeable material layers comprising a layer of woven or non woven fibrous materials 35 with an outer coating of a polymeric material 36 on the outer side of the fibrous layer 35. The fibrous reinforcement material 40 within the intumescent material provides a degree of structural strength so that in the event of the intumescent material charring in use the charred intumescent material will be supported to continue providing a smoke and fire barrier for a sufficient time for evacuation of a building, for instance. In this embodiment the layers are held together by stitching 38 as discussed above in relation to FIG. 2.

FIG. 5A shows the schematic result of a fire impinging upon the acoustic, smoke and fire barrier according to the present invention from the direction shown by the arrow 39. The intumescent material has formed a char 33 on the side of the barrier 30 which is exposed to the fire and the char has expanded to that side. The fibrous reinforcement 40, while partially distorted, supports the char 33. The side 37 of the barrier 30 which has not been exposed to the fire is substantially intact so that the layer of woven or non woven fibrous materials 35 with the outer coating of a polymeric material 36 on the outer side of the fibrous layer 35 remains intact and prevents smoke transmission through the barrier for at least sufficient time to enable evacuation of a building for instance. The stitches 38 have burned through on the charred side of the barrier but still exist on the unburned side 37.

In any of the embodiments in FIGS. 1 to 3 the intumescent material can comprises a formulation of an expandable graphite, binders and plasticizers to make a flexible material which when heated will expand and char to provide a significant barrier to transmission of heat and smoke. Such an intumescent material is made by Promat Australia Pty Ltd and sold under the trade mark Grafitex.

The fibrous reinforcement in the intumescent material may be a woven or non-woven fibreglass material, a fibreglass mesh material or a metallic mesh material. The woven or non-woven outer layer 16 or 34 can be a fibrous material such as fibreglass and the outer coating of polymeric material may for instance be a polyurethane material applied by spraying, dipping or painting.

The intumescent material may have a thickness of from 1 mm to 10 mm depending upon the required application.

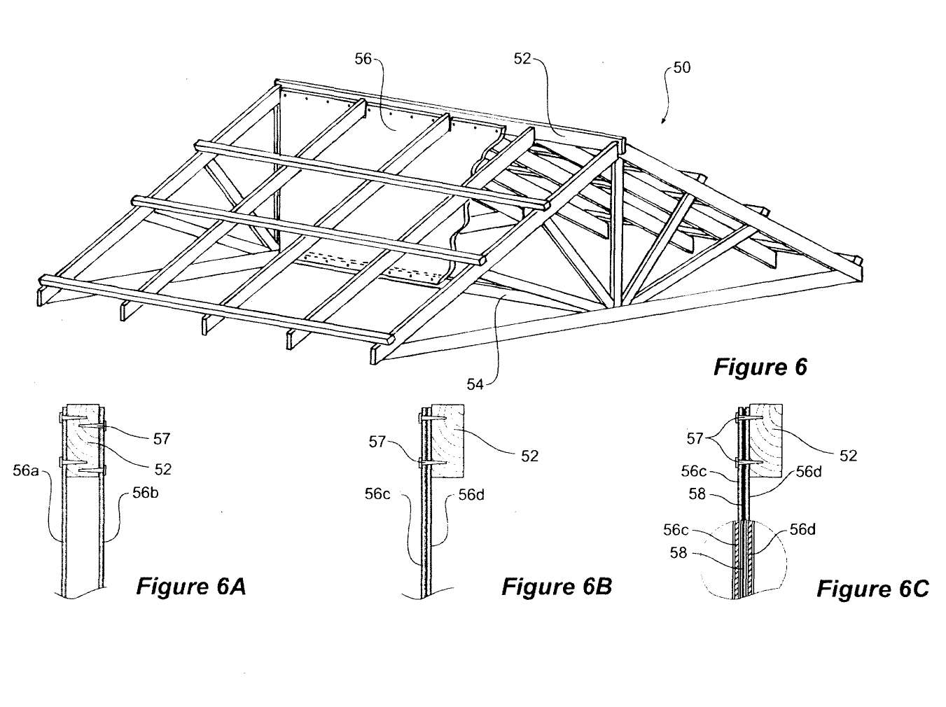

FIG. 6 shows a first possible application of the acoustic, fire and smoke barrier blanket of the present invention. In this embodiment a roof structure is schematically shown and the roof structure 50 includes an upper rafter 52 and lower rafter 54 with a sheet of the flexible acoustic, smoke and fire barrier material 56 fastened to them and extending between them. In this arrangement a fire or smoke which occurs in one part of the roof space will be prevented from travelling through to the other part of the roof space by the barrier. In effect in its usual state without a fire or smoke the flexible barrier provides an acoustic barrier across the void of the roof or ceiling space. In the event of smoke occurring in one half of the roof space then the flexible barrier will prevent the smoke transfer to the rest of the roof space. In the event of fire then flames infringing on the barrier will cause the intumescent material to expand to a char which will prevent heat transfer across the barrier. At the same time while the fibrous material on the fire side may disintegrate the barrier on the other side will prevent smoke from being transferred across the flexible barrier.

FIGS. 6A to 6C show alternative installations of the acoustic, fire and smoke barrier blanket of the present invention in a roof space.

In FIG. 6A there are two layers of the of the acoustic, fire and smoke barrier blanket 56a and 56b fastened one to each side of the upper rafter 52 by means of fasteners 57.

In FIG. 6B there are two layers of the of the acoustic, fire and smoke barrier blanket 56c and 56d fastened to one side of the upper rafter 52 by means of fasteners 57. The two layers can be joined together by at least one of gluing, stitching, strapping or stapling.

In FIG. 6C there are two layers of the of the acoustic, fire and smoke barrier blanket 56c and 56d fastened to one side of the upper rafter 52 by means of fasteners 57 and a layer of a heat reflective material such as an aluminium foil 58 between them. The lower part of the drawing of FIG. 6C shows a magnification to more clearly depict the configuration of the layers. The two layers of acoustic, fire and smoke barrier blanket and the heat reflective layer can be joined together by at least one of gluing, stitching or stapling or can be allowed to hang separately. Although two layers are shown in this embodiment here may be more than two layers in some situations.

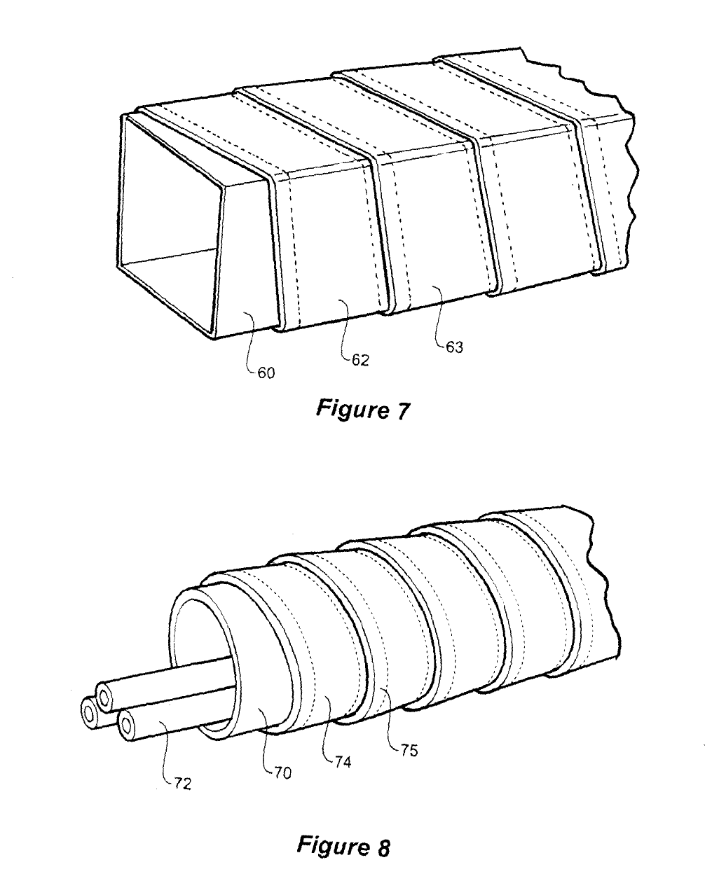

FIG. 7 shows an air-conditioning duct 60 about which is wrapped an elongated strip of the material of the present invention 62 with a small overlap 63 to provide complete coverage. In normal conditions the wrapping will provide some acoustic muffling for air passing through the duct. In the event of fire the intumescent material will expand and prevent heat and smoke from getting into the air-conditioning duct. The overlapping edges of the elongated strip may be adhered together if desired. For some applications there may be two layers of the elongated strip of the material of the present invention. The two layers can be applied separately or joined together before application. The two layers can be joined together by at least one of gluing, stitching, strapping or stapling.

FIG. 8 shows an arrangement for protection of a pipe 70 and for instance electrical cables 72 passing through the pipe. The pipe has wrapped around it an elongated strip of the material of the present invention 74 with a small overlap 75 to provide complete coverage. In the event of fire the intumescent material will expand and prevent heat and smoke from getting into the pipe and electrical cables. For some applications there may be two layers of the elongated strip of the material of the present invention. The two layers can be applied separately or joined together before application. The two layers can be joined together by at least one of gluing, stitching, strapping or stapling.

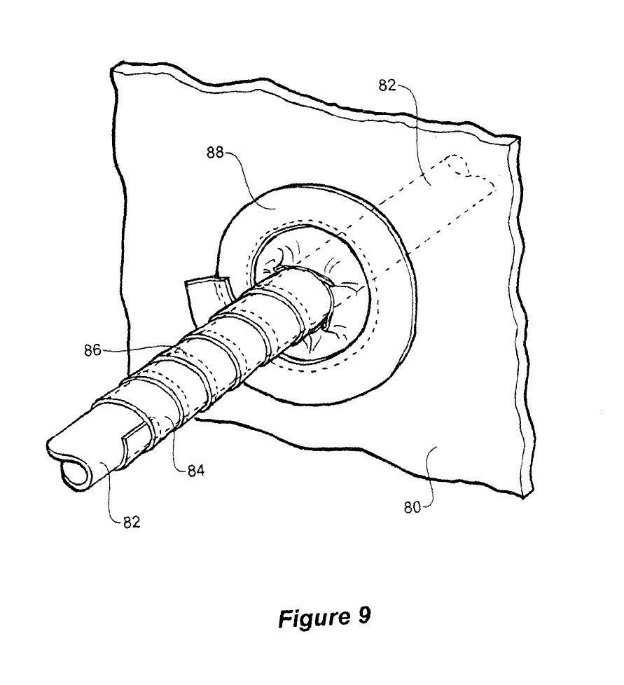

FIG. 9 shows an application of the device of the present invention used for prevention of heat transfer in the event of a fire through a barrier. In this embodiment a barrier 80, which may itself be fire resistant has a metallic material pipe 82 passing through it. In the event of a fire the pipe could conduct heat from one side of the barrier to the other which can be undesirable.

Impingement of heat onto the pipe and consequent conduction of heat along the pipe can be prevented according to the present invention by wrapping around it an elongated strip of the blanket material 84 of the present invention for a selected distance away from the harrier as shown in FIG. 9. There can be provided a small overlap 86 to provide complete coverage. Extra coverage 88 is provided where the pipe passes through the barrier by spreading the barrier material around that point against the barrier in a radial manner.

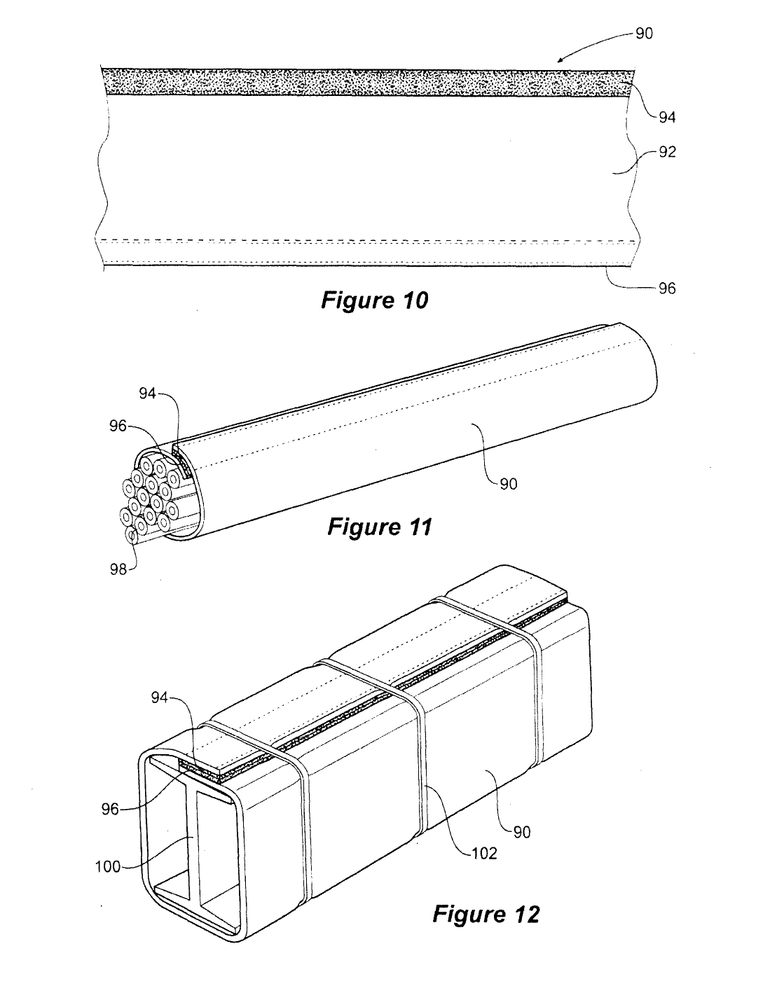

FIG. 10 shows an alternative embodiment of smoke and fire barrier according to the present invention. In this embodiment the an acoustic, smoke and fire barrier is constructed as a strip according any one of the embodiments shown in FIGS. 1 to 3 with the addition of complementary hook and loop fastening bands 94 and 96 on opposite sides and opposite faces. The strip of acoustic, smoke and fire barrier can be either used flat such as shown in FIG. 6 or can be wound spirally around a pipe or duct as shown, for instance in FIGS. 7 and 8. The complementary hook and loop fastening bands 94 and 96 on opposite sides and faces enable fastening. Although a single layer of smoke and fire barrier according to the present invention is shown in this embodiment there may be used multiple layers in some situations.

FIG. 11 shows one application of the smoke and fire barrier of FIG. 10 wrapped around electrical cables. In this embodiment the strip 90 of the embodiment shown in FIG. 10 wound transversely around a group of electrical cables 98 and joined using the complementary hook and loop fastening bands 94 and 96. The transverse, rather than spiral winding and connection by hook and look fastener allows easy access in the event the wires need to be repaired or replaced and then the smoke and fire barrier can be easily re-wrapped around the electrical cables. Although a bundle of cables is shown in the drawings the application of this embodiment of the invention may equally applicable to a single cable. Although a single layer of smoke and fire barrier according to the present invention is shown in this embodiment there may be used multiple layers in some situations.

FIG. 12 shows a further application of the smoke and fire barrier wrapped around a structural steel beam. Again the strip 90 of the embodiment shown in FIG. 10 is wound transversely, in this case around a structural steel I-beam 100 and joined using the complementary hook and loop fastening bands 94 and 96. The hook and loop fastening is complemented by the use of circumferential bands 102 at intervals along the I-beam. The smoke and fire barrier could alternatively be helically wound around the I-beam. Although a single layer of smoke and fire barrier according to the present invention is shown in this embodiment there may be used multiple layers in some situations.

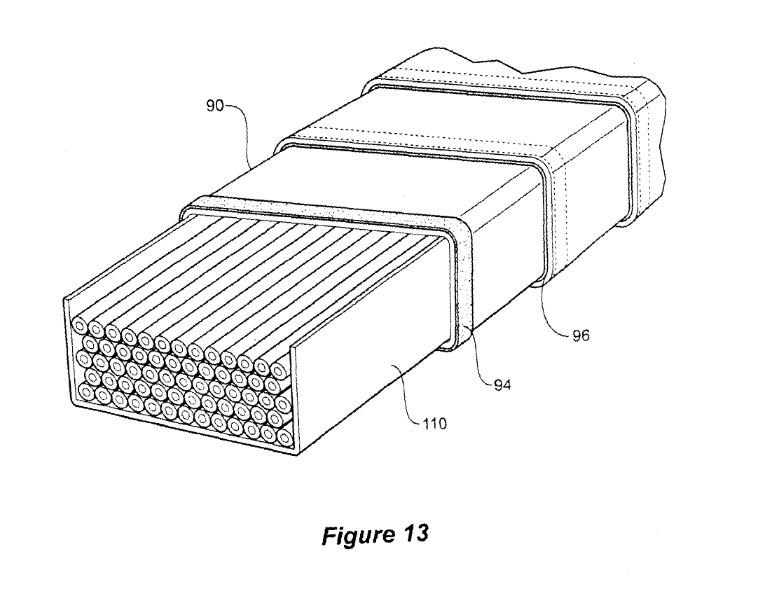

FIG. 13 shows a further application of the smoke and fire barrier of FIG. 10 wrapped around a cable tray. In this embodiment the strip 90 of the embodiment shown in FIG. 10 is wound spirally around a cable tray 110 but it could be also be placed by being wound transversely and adjacent edges connected by the hook and loop fastener strips 94, 96. The latter arrangement would allow the strip to be opened up to allow access to the cables and then the barrier to be closed again afterwards. Other methods of retaining the strip 90 of the embodiment shown in FIG. 10 onto the cable tray such as strapping using bands or the like are also applicable. Although a single layer of smoke and fire barrier according to the present invention is shown in this embodiment there may be used multiple layers in some situations.

Throughout this specification various indications have been given as to the scope of the invention but the invention is not limited to any one of these but may reside in two or more combined together. The examples are given per illustration only and not for limitation.

1. A flexible fire, sound and smoke barrier comprising a sheet of flexible intumescent material, the sheet of flexible intumescent material comprising a first side and a second side, and first sheet of smoke impermeable material on the first side of the sheet of flexible intumescent material and the first sheet of smoke impermeable material being fastened to the first side of the sheet of flexible intumescent material and a second sheet of smoke impermeable material on the second side of the sheet of flexible intumescent material and the second sheet of smoke impermeable material being fastened to the second side of the sheet of flexible intumescent material, the first and second sheets of smoke impermeable material comprising a woven or non-woven sheet of fibrous material and a coating of a polymeric material on at least one side thereof.

2. A flexible fire, sound and smoke barrier as in claim 1 wherein the sheet of flexible intumescent material comprises a formulation of expandable graphite, binders and plasticisers.

3. A flexible fire, sound and smoke barrier as in claim 1 wherein the sheet of flexible intumescent material comprises a thickness of from 1 mm to 10 mm.

4. A flexible fire, sound and smoke barrier as in claim 1 wherein the first and second sheets of smoke impermeable material comprise a fibreglass fibrous material.

5. A flexible fire, sound and smoke barrier as in claim 1 wherein the coating of a polymeric material on at least one side of the first and second sheets of smoke impermeable material comprise a polyurethane polymeric material.

6. A flexible fire, sound and smoke barrier as in claim 1 wherein the first and second sheets of smoke impermeable material are fastened respectively to the sides of the sheet of flexible intumescent material by at least one of gluing, stitching or stapling.

7. A flexible fire, sound and smoke barrier as in claim 1 wherein the sheet of flexible intumescent material comprises a fibrous reinforcement.

8. A flexible fire, sound and smoke barrier as in claim 7 wherein the fibrous reinforcement comprises a sheet of textile material embedded into the intumescent material.

9. A flexible fire, sound and smoke barrier as in claim 8 wherein the sheet of textile material embedded into the intumescent material comprises woven or non-woven fibreglass.

10. A flexible fire, sound and smoke barrier as in claim 1 wherein the sheet of flexible intumescent material comprises a metal mesh reinforcement.

11. A flexible fire, sound and smoke barrier as in claim 1 wherein the fire, sound and smoke barrier comprises an elongate strip, the strip having opposite longitudinal edges and complementary hook and loop fastening bands being on the opposite longitudinal edges on opposite faces.

12. A flexible fire, sound and smoke barrier comprising a sheet of flexible intumescent material, the sheet of flexible intumescent material comprising a first side and a second side, and first sheet of smoke impermeable material on the first side of the sheet of flexible intumescent material and the first sheet of smoke impermeable material being stitched to the first side of the sheet of flexible intumescent material and a second sheet of smoke impermeable material on the second side of the sheet of flexible intumescent material and the second sheet of smoke impermeable material being stitched to the second side of the sheet of flexible intumescent material, the first and second sheets of smoke impermeable material comprising a woven or non-woven sheet of fibreglass material and a coating of a polymeric material on at least one side thereof and the sheet of flexible intumescent material comprises a fibrous reinforcement layer.

13. A flexible fire, sound and smoke barrier as in claim 12 wherein the first and second sheets of smoke impermeable material are stitched together through the sheet of flexible intumescent material.

14. A flexible fire, sound and smoke barrier as in claim 12 wherein the sheet of flexible intumescent material comprises a formulation of expandable graphite, binders and plasticisers.

15. A flexible fire, sound and smoke barrier as in claim 12 wherein the sheet of flexible intumescent material comprises a thickness of from 1 mm to 10 mm.

16. A flexible fire, sound and smoke barrier as in claim 12 wherein the coating of a polymeric material on at least one side of the first and second sheets of smoke impermeable material comprise a polyurethane polymeric material.

17. A flexible fire, sound and smoke barrier as in claim 12 wherein the fibrous reinforcement layer comprises a material selected from the group comprising a woven fibreglass, a non-woven fibreglass and a metal mesh.

18. A flexible fire, sound and smoke barrier comprising a plurality of sheets of fire and smoke barrier as defined in any one previous claim, the plurality of sheets being fastened together.

19. A flexible fire, sound and smoke barrier as in claim 18 wherein the plurality of sheets of fire and smoke barrier are fastened together by at least one of gluing, stitching or stapling.

20. A flexible fire, sound and smoke barrier as in claim 18 wherein the plurality of sheets of fire and smoke barrier further include a heat reflective material layer between at least two of the plurality of sheets.
